(19) United States
(12) Patent Application Publication
(10) Pub. No.: US 2009/0077338 A1
(43) Pub. Date: Mar. 19, 2009

(54) Apparatus and Method for Managing Storage Systems

(75) Inventors: John P. Agombar, Winchester (GB); Christopher B. Beeken, Eastleigh (GB); Stephanie Machleidt, Winchester (GB); William J. Scales, Portchester (GB); Simon Walsh, Hampshire (GB)

Correspondence Address: LIEBERMAN & BRANDSDORFER, LLC, 802 STILL CREEK LANE, GAITHERSBURG, MD, 20878, US

(73) Assignee: INTERNATIONAL BUSINESS MACHINES CORPORATION, Armonk, NY (US)

(21) Appl. No.: 12/190,043

(22) Filed: Aug. 12, 2008

(30) Foreign Application Priority Data
Aug. 23, 2007 (EP) 07114885.2

(51) Int. Cl. G06F 12/02

(52) U.S. Cl. 711/170

(57) ABSTRACT

An apparatus for controlling a configuration change in a storage system having a plurality of storage appliances with an I/O handler local to each storage appliance for transmitting and receiving I/O requests. A local volume mapper local to each storage appliance maps storage local to the storage appliance; a remote volume mapper local to each storage appliance maps storage remote from the or each storage appliance; and a spanning host interface layer responsive to detection of the configuration change receives and redirects I/O requests among the plurality of storage appliances.

### FIELD OF THE INVENTION

The present invention relates to a technology for improved management of storage systems, and more particularly to a technology for managing storage systems having storage virtualization appliances.

### BACKGROUND OF THE INVENTION

The demand for greater capacity, a multitude of different host types and the need to manage storage non-disruptively with respect to the host applications means that the scheduling and managing of storage system maintenance becomes very complex and expensive. In order to reduce the complexity of the storage system it may become desirable to merge storage resources. The storage administrator may wish to reduce the number of storage appliances that need to be managed. This may be because either the current appliances can be upgraded to cope with more resources or a new appliance may be available that can manage a greater portion of the current storage resources. The administrator's task therefore is to consolidate different storage resources while minimizing the impact on the user (i.e. host applications). It will be clear to one of ordinary skill in the art that the same, or similar, disadvantages apply to other administrative and system management actions, but for ease of understanding the present description will be confined to the situation described above.

FIG. 1 shows an exemplary storage configuration before the resources are merged and FIG. 2 shows the corresponding desired configuration after the merge. In the figures the initial system is made up of two storage appliances, (104) and (120), servicing hosts (100) and (116), respectively. If an appliance (105) that is capable of controlling all the storage becomes available, it would be desirable to merge the storage resources of appliances (104) and (120) into appliance (105) as shown in FIG. 2. Then appliances (104) and (120) could be “decommissioned.” Alternatively, appliance (105) could be an upgrade version of either appliance (104) or appliance (120), in which case, the upgrade version would remain in service while the other could be decommissioned at the end of the merge.

There are a number of ways this could be achieved according to the prior art. For example: the system could be taken down on appliances (104) and (120) and rebuilt on appliance (105), but this obviously means disrupting all the host applications; or the volumes on appliances (104) and (120) could be mirrored onto appliance (105), but this requires additional storage being made available in order to maintain two copies of the volumes.

It would thus be desirable to have an improved technology for managing storage systems having storage virtualization appliances.

### SUMMARY OF THE INVENTION

The present invention accordingly provides, an apparatus, system, and article form managing storage systems having two or more appliances.

In one aspect, an apparatus is provided for controlling a configuration change in a storage system having a plurality of storage appliances. An I/O handler and a local volume mapper are provided local to each storage appliance. The I/O handler transmits and receives I/O requests, and the local volume mapper maps storage local to the respective storage appliance. A remote volume mapper is provided local to each storage appliance for mapping storage remote from the respective storage appliance. In addition, a spanning host interface layer is provided local to each storage appliance to respond to detection of a configuration change by receiving and redirecting I/O requests among said plurality of storage appliances.

In another aspect, a method is provided for controlling a configuration change in a storage system having a plurality of storage appliances. I/O requests are transmitted and received by an I/O handler local to each storage appliance. A local volume mapper is provided for mapping storage local each storage appliance. Similarly, a remote volume mapper is provided at each storage appliance for mapping storage remote from the local storage appliance. In response to detection of the configuration change, I/O requests are received and redirected among the storage appliances by a spanning host interface layer.

In yet another aspect of the invention, an article is provided with a computer data carrier having computer program instructions configured to manage a configuration change in a storage system. Instructions are provided to transmit and receive I/O requests by an I/O handler at each storage appliance. In addition, instructions are provided to map storage local to the storage appliance. A local volume mapper at each storage appliance is employed to map local storage. Instructions are also provided to map storage remote from the storage appliance. A remote volume mapper at each storage appliance may the remote storage. In response to detection of a configuration change, instructions are provided to receive and redirect I/O requests among the plurality of storage appliances by a spanning host interface layer.

Embodiments of the present invention, in its broadest aspect, provide apparatus and methods for performing management actions, such as merging storage resources from one storage appliance with another, without loss of access.

### BRIEF DESCRIPTION OF THE DRAWINGS

A preferred embodiment of the present invention will now be described, by way of example only, with reference to the accompanying drawing figures, in which:

FIG. 1 shows in schematic form an arrangement of apparatus in which a preferred embodiment of the present invention may be embodied in a “before” state;

FIG. 2 shows in schematic form an arrangement of apparatus in which a preferred embodiment of the present invention may be embodied in an “after” state;

FIGS. 3-6 show in schematic form a sequence of configuration states of an apparatus or arrangement of apparatus in accordance with a preferred embodiment of the present invention;

FIG. 7 shows in simplified schematic form an arrangement of components in accordance with a preferred embodiment of the present invention; and

FIG. 8 shows in flowchart form one method or logic arrangement in which a preferred embodiment of the present invention may be implemented.

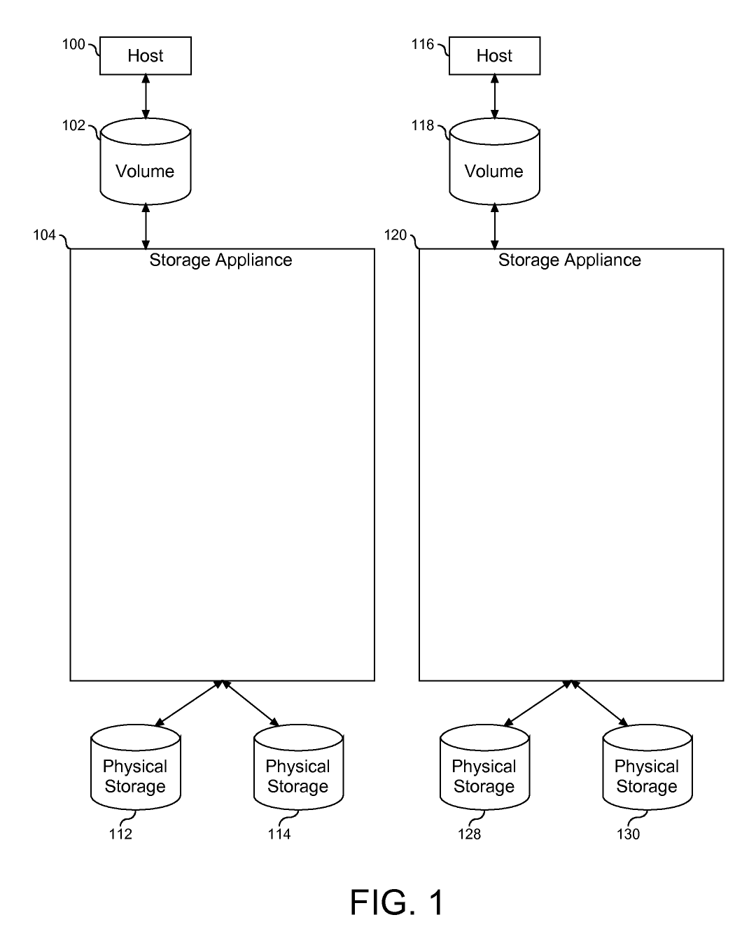

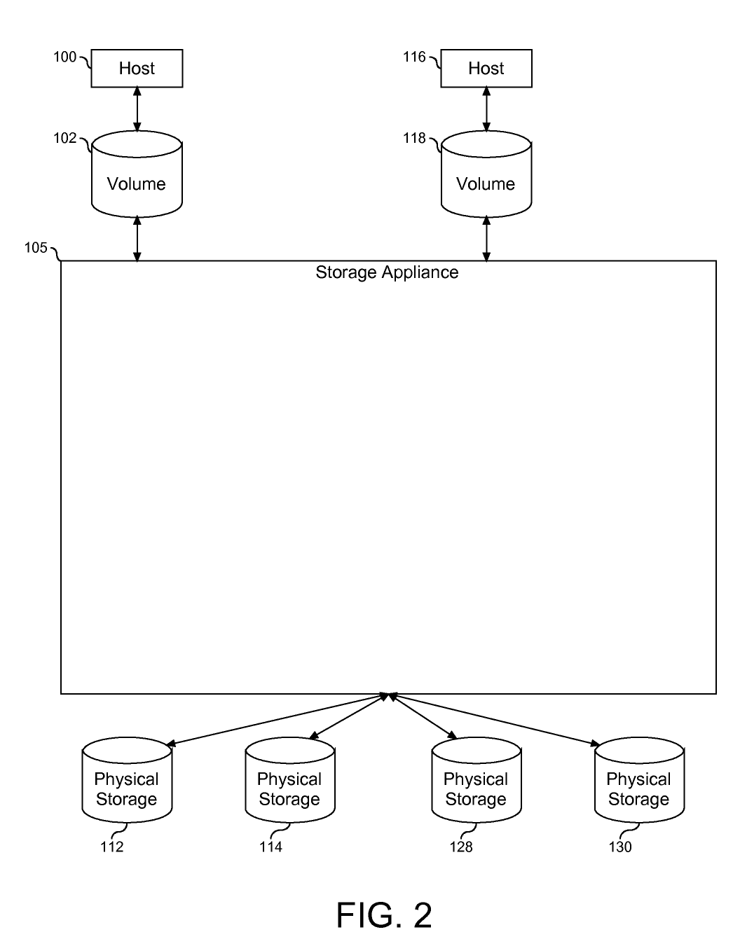

### DETAILED DESCRIPTION OF THE PREFERRED EMBODIMENTS

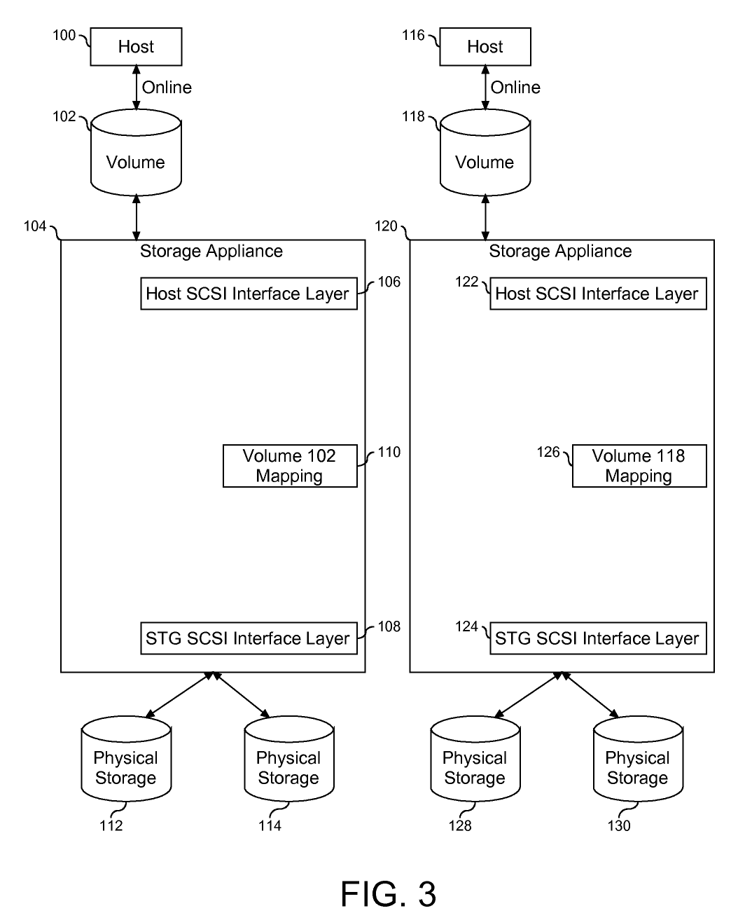

A preferred embodiment of the present invention will now be described, with reference to the figures, beginning at FIG. 3. FIG. 3 shows two appliances (104), (120) which present virtual storage volumes (102) and (108) to hosts (100) and (116), respectively, in order to manage I/O for physical storage (112), (114), (128), (130). The presentation of storage to hosts (102), (116) is achieved using volume mappings, shown as VOL (102) MAPPING (110) and VOL (118) MAPPING (126) to map the physical storage (112), (114) and (128), (130), respectively. I/O between host (100) and storage appliance (104) is directed through host-SCSI interface layer (106), and I/O between host (116) and storage appliance (120) is directed through host-SCSI interface layer (122). I/O between storage appliance (104) and physical storage (112), (114) is directed through storage-SCSI interface layer (108), and I/O between storage appliance (120) and physical storage (128), (130) is directed through storage-SCSI interface layer (124).

The storage administrator wishes to merge appliance (104) into appliance (120) in the sense that appliance (120) will present both volumes (102) and (108) without impacting access for hosts (100) and (116). It will be clear to one of ordinary skill in the art that, though the description of the preferred embodiment is cast in terms of the Small Computer System Interface or SCSI protocols, any other set of system interface protocols may be substituted.

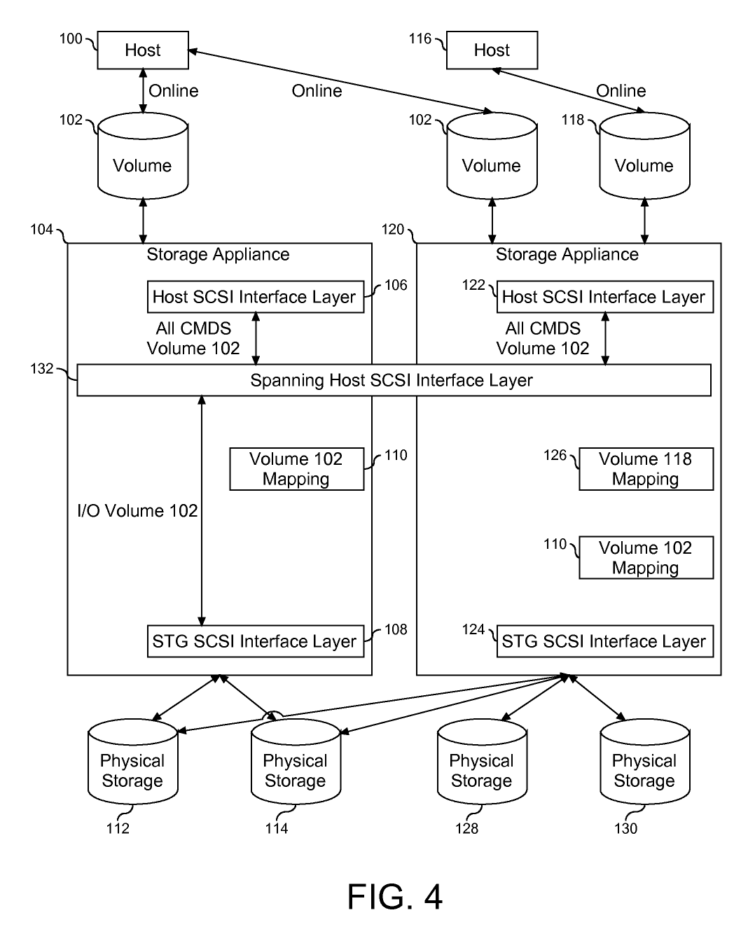

The preferred embodiment of the present invention makes use of a spanning host SCSI interface layer (132), as shown in FIG. 4. This interface layer (132) is created so as to facilitate linkage between the two appliances (104), (120) and to forward I/O either to storage managed by appliance (104) or appliance (120) as appropriate. In one embodiment, the spanning host interface layer receives and redirects I/O requests from a first storage appliance to a second storage application during a merge of the first and second storage appliance. Similarly, in one embodiment, the spanning host interface layer receives and redirects I/O requests from the first and the second storage appliance to a third storage appliance during the merge of the first and second storage appliance in the third storage appliance. Advantageously, no extra storage is required and the management action (in this exemplary case, a merge) is transparent to the host applications.

The two appliances (104) and (120) are merged using the following sequence of operations, with reference to FIG. 4:
1. Extract the metadata for volume (102) from appliance (104).
2. Map physical storage (112), (114) of appliance (102) to appliance (120).
3. Using the metadata for volume (102) create a volume on appliance (120) that maps to the appropriate regions on the physical storage (112), (114) from appliance (104).
4. Start the spanning host SCSI layer for volume (102) between the two appliances. This layer will forward all I/O received for volume (102) on appliance (120) to appliance (104).
5. Map the new volume from appliance (104) to host (100). Host (100) will see the new volume as another path available to volume (102).
   The spanning layer is required because it is not sufficient to just allow both appliance (102) and appliance (120) to access the same physical storage at the same time. Physical storage is usually managed by a redundant RAID controller. Many of these RAID controllers require all I/O requests to a particular physical volume to be directed to the same half of the controller to avoid LUN thrashing. Therefore if two appliances need to share the same storage they would need to jointly decide which half of the controller to use for each physical volume.

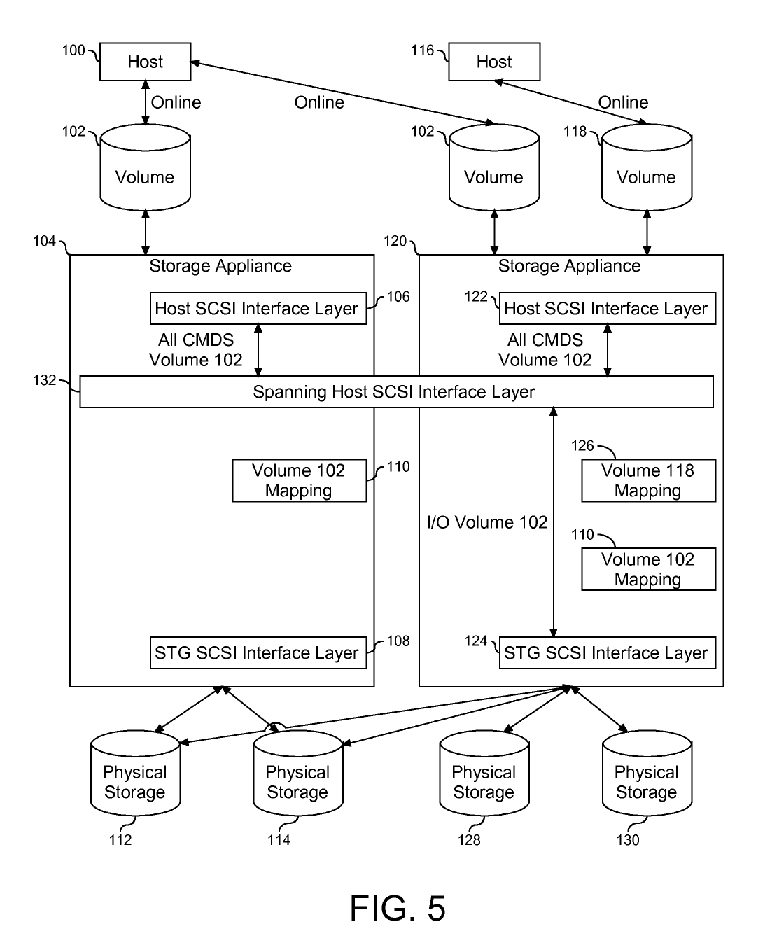

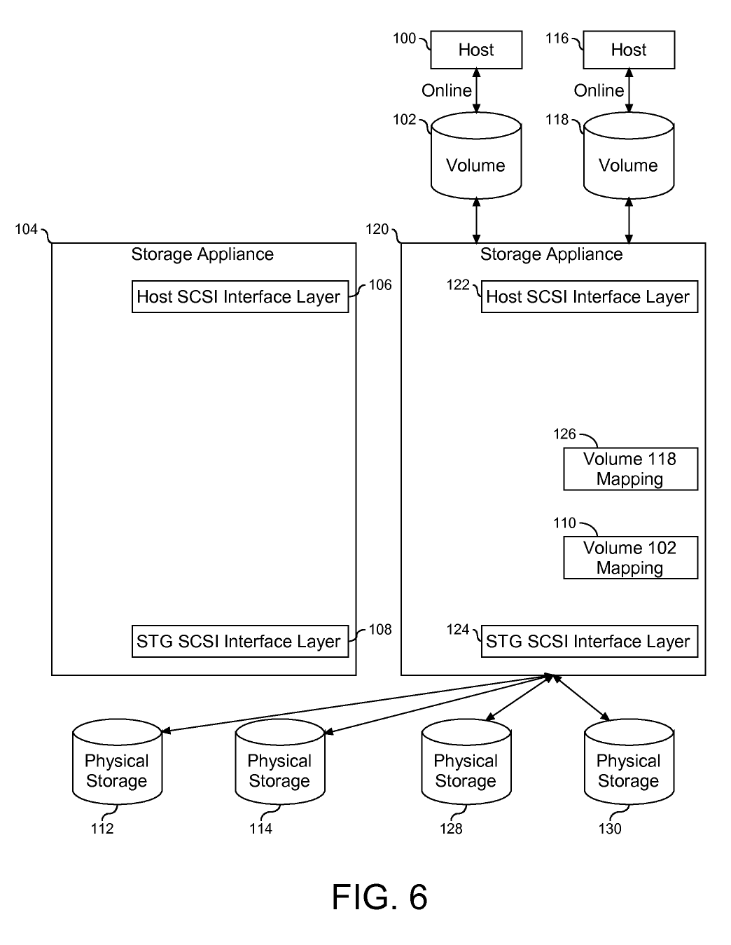

Turning now to FIG. 5, the following sequence of steps is performed:
1. Flush any cached data in appliance (104) for volume (102).
2. Offline the path from appliance (104) to host (100). This causes host (100) to start using the paths to volume (104) through appliance (120).
3. Fail any outstanding I/O in appliance (104).
4. Quiesce I/O in appliance (120) for volume (102), instruct the spanning layer to stop forwarding I/O and start performing I/O for the physical storage (112), (114) through appliance (120) instead of appliance (104).
   The configuration of volume (102) in appliance (104) (i.e. virtual mapping, host mapping, etc.) can now be removed as shown in FIG. 6, wherein all I/O for all the physical storage and for both mapped volumes (102) and (118) is performed using appliance (120). As will be clear to one of ordinary skill in the art, the sequence of steps to implement the method described above can be initiated by issuing a single command on either cluster instructing it to merge virtual storage onto one of the appliances. It will also be clear to one of ordinary skill in the art that other methods of initiating the merge are possible; such as by execution of a script, execution of a trigger event, or the like.

The process of the preferred embodiment can be repeated for any number of volumes on any number of clusters. The process is independent for each volume and so can be done in parallel.

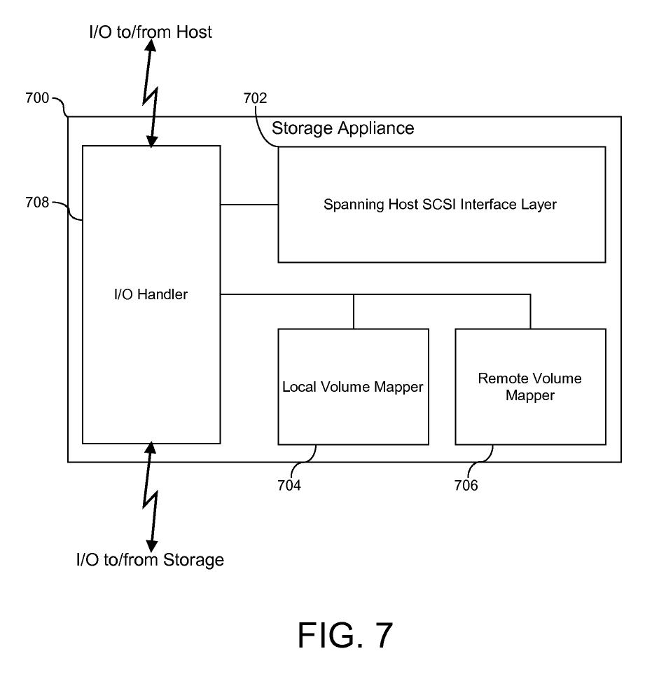

An exemplary apparatus or arrangement of apparatus according to the preferred embodiment will now be described, with reference to the schematic diagram of FIG. 7. FIG. 7 shows a storage appliance (700) having, in addition to the normal host and storage SCSI interface layers (not shown in this figure for ease of reading), a spanning host SCSI interface layer (702). The I/O handler (708) is adapted to send and receive I/Os between the host and the storage and to present one or more volumes to the host using local volume mapper (704) in the conventional fashion, but is also adapted to present one or more volumes to the host using remote volume mapper (706). The apparatus or arrangement of apparatus in accordance with FIG. 7 is thus adapted to perform the process as described above.

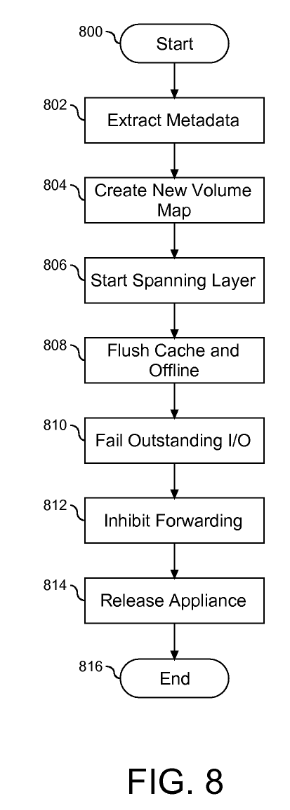

The preferred embodiment of the present invention in the form of an apparatus or arrangement of apparatus thus advantageously addresses the problem of providing a technical means for managing storage systems having storage virtualization appliances. An exemplary method or logic arrangement according to the preferred embodiment will now be described, with reference to the schematic diagram of FIG. 8. The process of the preferred embodiment shown in FIG. 8 starts at START step (800). At step (802), volume metadata is extracted and at step (804), the physical storage for the volume that is to be migrated from (104) is mapped to a new volume map at the new location. At step (806), the spanning host SCSI layer (132) is started and the new volume map is presented to host (100). At step (808), the cached data at the appliance to be migrated from (104) is flushed and the path from the host (100) to the appliance to be migrated from (104) is offlined. Outstanding I/O at the appliance to be migrated from (104) is failed at step (810). At step (812), I/O at the device to be migrated to (120) is quiesced and the spanning layer (132) is inhibited from forwarding I/O through the appliance to be migrated from (104). I/O is now performed via the appliance to be migrated to (120). At step (814), the appliance to be migrated from (104) is released from service and can be decommissioned, and at END step (816) the process completes.

The preferred embodiment of the present invention in the form of a method or logic arrangement thus advantageously addresses the problem of providing a technology for managing storage systems having storage virtualization appliances.

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the preferred embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, the preferred embodiment of the present invention may be realized in the form of a computer implemented method of deploying a service comprising steps of deploying computer program code operable to, when deployed into a computer infrastructure and executed thereon, cause the computer infrastructure to perform all the steps of the method.

In a further alternative, the preferred embodiment of the present invention may be realized in the form of a data carrier having functional data thereon, the functional data comprising functional computer data structures to, when loaded into a computer system and operated upon thereby, enable the computer system to perform all the steps of the method.

It will be clear to one skilled in the art that many improvements and modifications can be made to the foregoing exemplary embodiment without departing from the scope of the present invention.

What is claimed is:

1. An apparatus for controlling a configuration change in a storage system having a plurality of storage appliances and comprising:
an I/O handler local to each storage appliance to transmit and receive I/O requests;
a volume mapper local to each storage appliance to map storage local to each storage appliance;
a remote volume mapper local to each storage appliance to map storage remote from the local storage appliance; and
a spanning host interface layer in communication with each storage appliance to receive and redirect I/O requests among said plurality of storage appliances responsive to detection of a configuration change.

2. The apparatus of claim 1, wherein the configuration change is a merge of the storage appliances and wherein the spanning host interface layer is adapted to receive and redirect I/O requests from a first storage appliance to a second storage appliance during the merge of said storage appliances.

3. The apparatus of claim 1, wherein the configuration change is a merge of the storage appliances and wherein the spanning host interface layer is adapted to receive and redirect I/O requests from a first and a second of said plurality of storage appliances to a third of said plurality of storage appliances during the merge of said first storage appliance and said second storage appliance into said third storage appliance.

4. The apparatus of claim 1, wherein said plurality of storage appliances comply with SCSI protocols, and wherein said spanning host interface layer complies with SCSI protocols.

5. A method for controlling a configuration change in a storage system having a plurality of storage appliances, comprising:
transmitting and receiving I/O requests by an I/O handler at each storage appliance;
mapping, by a local volume mapper at each storage appliance, storage local to the storage appliance;
mapping, by a remote volume mapper at each storage appliance, storage remote from the storage appliance; and
responsive to detection of a configuration change, receiving and redirecting I/O requests among said plurality of storage appliances, by a spanning host interface layer.

6. The method of claim 5, wherein the configuration change is a merge of the storage appliances, and further comprising the spanning host interface layer receiving and redirecting I/O requests from a first of said plurality of storage appliances to a second of said plurality of storage appliances during the merge of a first storage appliance with a second storage appliance.

7. The method of claim 5, wherein the configuration change is a merge of the storage appliances, and further comprising the spanning host interface layer receiving and redirecting I/O requests from a first and a second of said plurality of storage appliances to a third of said plurality of storage appliances during the merge of a first storage appliance and a second storage appliance with a third storage appliance.

8. The method of claim 5, wherein said plurality of storage appliances comply with SCSI protocols, and wherein said spanning host interface layer complies with SCSI protocols.

9. An article comprising:
a computer data carrier including computer program instructions configured to manage a configuration change in a storage system, the instructions comprising:
instructions to transmit and receive I/O requests by an I/O handler at each storage appliance;
instructions to map, by a local volume mapper at each storage appliance, storage local to the storage appliance;
instructions to map, by a remote volume mapper at each storage appliance, storage remote from the storage appliance; and
responsive to detection of a configuration change, instructions to receive and redirect I/O requests among said plurality of storage appliances, by a spanning host interface layer.

10. The article of claim 9, wherein the configuration change is a merge of the storage appliances, and further comprising instructions for the spanning host interface layer to receive and redirect I/O requests from a first of said plurality of storage appliances to a second of said plurality of storage appliances during the merge of a first storage appliance with a second storage appliance.

11. The article of claim 9, wherein the configuration change is a merge of the storage appliances, and further comprising instructions for the spanning host interface layer to receive and redirect I/O requests from a first and a second of said plurality of storage appliances to a third of said plurality of storage appliances during the merge of a first storage appliance and a second storage appliance with a third storage appliance.

12. The article of claim 9, wherein said plurality of storage appliances comply with SCSI protocols, and wherein said spanning host interface layer complies with SCSI protocols.
